(19) United States
(12) Patent Application Publication
(10) Pub. No.: US 2011/0198820 A1
(43) Pub. Date: Aug. 18, 2011

(54) Stabilizer and a method for producing a stabilizer

(75) Inventors: Andreas Janzen, Willebadessen (DE); Ullrich Hammelmeier, Paderborn (DE); Sebastian Saggel, Paderborn (DE); Friso Berheide, Rheda-Wiedenbruck (DE); Bernhard Hofmann, Willebadessen (DE); Christian Smatloch, Paderborn (DE); Wulf Härtel, Bad Oeynhausen (DE); Christian Ditter, Paderborn (DE)

(73) Assignee: Benteler Automobiltechnik GmbH, Paderborn (DE)

(21) Appl. No.: 13/024,713

(22) Filed: Feb. 10, 2011

(30) Foreign Application Priority Data
Feb. 16, 2010 (DE) 10 2010 008 164.7
Sep. 9, 2010 (DE) 10 2010 044 799.4

(51) Int. Cl. B60G 21/055; B23P 11/02

(52) U.S. Cl. 280/124.106; 29/447

(57) ABSTRACT

The present invention relates to a stabilizer (1, 26) which has at least two stabilizer components which are coupled with one another materially by thermal joining, characterized in that a heat-affected zone (7) produced by the thermal joining is at least partially heat treated after coupling.

The present invention also relates to a method for producing a stabilizer (1, 26), wherein at least two stabilizer components are connected with one another by thermal joining, characterized in that the heat-affected zone (7) produced by the thermal joining is heat-treated.

The present invention relates to a stabilizer which includes at least two stabilizer components according to the preamble of claim 1.

The present invention also relates to a method for producing a stabilizer according to the preamble of claim 11.

Several methods for producing split tubular stabilizers are known in the art. A coupling method is known from DE 199 30 444 C2, wherein a non-rotatable connection between a tubular stabilizer half and a tilt motor is realized via separate coupling members. Disadvantageously, this method has relatively high complexity and production costs due to the use of different components and coupling members.

DE 102 37 103 A1 also discloses a method for producing a split tubular stabilizer. The ends of the tubular stabilizer halves are here directly connected by laser welding either with a housing part of a tilt motor or with a connection element. To prevent overstressing of the produced weld seam during travel when transmitting high torques, it is proposed to ensure that the weld joint has a large diameter. However, the joints disclosed in this document have properties that do not always satisfy the demands due to changing dynamical stress in operation.

DE 10 2004 057 429 B4 discloses a method for producing a split tubular stabilizer with a tilt motor which couples two tubular stabilizer halves, wherein the tubular stabilizer halves are directly coupled to the tilt motor by thermal joining. According to the method, the tube end of the tubular stabilizer half is prepared by simultaneously expanding and upsetting by increasing the wail thickness for the coupling process, so that a high-quality attachment for the weld seam and a large diameter for transmitting high torques is produced.

Disadvantageously, however, the process of machining the tube ends according to DE 10 2004 057 429 B4 cannot always be designed for a reliable production. Finish-machining of the tube end may be required. Moreover, simultaneously expanding and upsetting produces an omnidirectional material flow which may negative affect the strength in the attachment region.

It is therefore an object of the present invention to provide a multipart stabilizer with which a high-strength permanent attachment can be reliably produced at low cost. It is also an object of the invention to provide a method for producing a multipart stabilizer.

The aforementioned object is attained according to the invention with a stabilizer according to claim 1. The object relating to the method is further attained with a method for producing a stabilizer according to claim 11.

Advantageous embodiments of the present invention are recited in the dependent claims.

The stabilizer according to the invention, which has at least two stabilizer components connected with one another by thermal joining, is characterized in that a heat impact zone created by the thermal joining is at least partially heat-treated after coupling.

In the context of the invention, stabilizer components refer to components that have, for example, a tube, a tube segment, a solid material segment, an actuator, or various other components which mainly extend in the longitudinal direction of the respective stabilizer on its considered segment. In a particularly advantageous embodiment of the present invention, the stabilizer components, which consist mostly of metallic materials, for example steel materials, but also light metal materials, are coupled with one another.

The coupling is here performed by thermal joining, for example by a welding process which may be performed by laser welding, MIG-, WIG- or MAG-welding or also by friction stir welding or friction welding. Thermal joining creates a heat-affected zone in the respective end regions of the coupled components. The heat-affected zone has mostly undesirable microstructures, which again adversely affects the durability and/or fatigue strength.

For example, the strength of preassembled hardened components may be diminished by the heat-affected zone, which is disadvantageous for the durability of the tubular stabilizer. In addition, air inclusions or hard microstructures may be present which also adversely affect the durability of the produced joint.

The solution according to the invention with partial heat treatment of the heat-affected zone makes it hence possible to post-treat these undesirable effects arising from thermal joining in the produced stabilizer and to render them irrelevant for the demands during the operation and the durability of the stabilizer. The stabilizer can then be cost-effectively post-treated so that the torsion characteristic or durability of the stabilizer is no longer impaired as a result of the heat-affected zone produced by thermal joining.

In a particularly preferred modified embodiment of the present invention, the stabilizer components are coupled with one another by a circumferential joint seam, wherein the joint seam and the heat-affected zone surrounding the joint seam are heat-treated. Within the context of the invention, the term circumferential joint seam refers to a joint seam which extends once around the stabilizer in relation to the stabilizer axis. A particular advantage of the circumferential and whole-area heat treatment of the joint seam and the heat-affected zone surrounding the joint seam is that the undesirable changes in the microstructure, caused by thermal joining, almost entirely disappear. A material coupling of the stabilizer components is produced and a continuous homogeneous microstructure in the heat-affected zone is created. Preferably, a fine-grain martensitic microstructure is produced. Due to the welding additive used during the thermal joining process, the joined material is not contiguously homogeneous, which is, however, compensated at least partially with the heat treatment according to the invention. This has a particularly advantageous effect on the desired durability of the stabilizer.

Advantageously, two stabilizer halves are connected with one another via an actuator. According to the invention, the stabilizer halves as well as the actuator are stabilizer components. The term stabilizer halves in the context of the invention is to be understood as splitting the stabilizer into stabilizer halves with a ratio of about 50:50 along the longitudinal axis of the actuator. However, within the context of the invention in relation to the stabilizer halves, the stabilizer may also be split along its longitudinal axis with a ratio of 90:10, 80:20, 70:30 or 60:40, or a mix of the aforementioned spitting ratio.

These stabilizer halves are then connected with one another via an actuator. An actuator in the context of the invention refers to an actuating means, which is preferably driven electromechanically, but also pneumatic-hydraulically and the like, in order to actively adjust the roll behavior. According to the invention, the couplings of the stabilizer halves with the actuator or of the stabilizer halves with each other are also heat-treated after thermal joining. The actuator itself produces increased torsion forces inside the stabilizer. Advantageously, due to the thermal post-treatment according to the invention after thermal joining, these increased forces are very effectively transferred by the stabilizer in the coupling locations. The stress curve produced by the forces is hence optimized.

In another preferred embodiment, each stabilizer half has a flange and a tube which is materially connected to the flange. Within the context of the invention, the term flange refers to attachment means which may be, for example, a cast part, a milled part or a similar part. The flange is again made from a metallic material, for example from a steel material, but also from a light metal. The flange and also the stabilizer half in form a tubular segment or a solid material segment are then again materially coupled with one another.

Particularly advantageous within the context of the invention is, for example, that a steel material can be coupled with a light metal material, for example an aluminum material, by friction stirring welding. The changes in the microstructure at the coupling location and also in the heat-affected zone surrounding the coupling location can be homogenized by the heat post-treatment according to the invention. This desired magnitude of the homogenization is selected so that no hardened regions or brittle microstructures remain in the heat-affected zone or the coupling location. This is particularly advantageous for the durability and the response of the stabilizer.

Another preferred modified embodiment, the flange has on the side facing the tube a connection region which is preferably constructed as a connecting piece. In the context of the invention, the term connecting piece refers to a preferably cylindrical extension of the flange. However, it could also be an extension in the shape of a funnel, cone, truncated cone and the like. In the region of the coupling location with the end of the stabilizer half, the connecting piece has preferably an outside and/or inside diameter which substantially corresponds to the geometric dimensions of the tube end. This is particularly advantageous for the produced weld joint. In the context of the invention, the connection region may be formed by the connecting piece in form of a butt joint or an overlap or, for example, also an interference fit. For example, the connecting piece may encompass the stabilizer half or, with a tubular stabilizer, the tubular stabilizer half may encompass the connecting piece.

In another preferred modified embodiment, the tube end facing the flange is expanded relative to an initial diameter of the tube, wherein the wall thickness of the expanded end preferably corresponds substantially to the wall thickness of the tube. With the expanded tube end, the same or a higher torsion torque can be transmitted across the coupling location edge, while at the same time stress produced by the torsion reduced. However, expansion would reduce the wall thickness on the expanded end. This can be compensated by an upsetting process, so that the wall thickness then corresponds substantially to the wall thickness of the initial tube. Within the context of the invention, both the stabilizer and the connection region of the flange should have approximately the same wall thickness in the connection region to the flange. This has a particularly advantageous effect on the coupling to be produced.

Preferably, the outside diameter of the connecting piece corresponds substantially to the outside diameter of the expanded tube end. This likewise has a particularly advantageous effect on the produced thermal joint. Within the context of the invention, identical outside diameters in the connection region facilitate heat treatment following thermal joining.

In another particularly preferred modified embodiment within the context of the invention, the heat treatment is performed in several stages and/or steps. The term several stages within the context of the invention indicates that heat treatment is performed so that within a heat treatment step several stages of the heat treatment follow each other directly without a break. These stages can include multiple increases or reductions in the temperature, or the temperature may be held constant during the different time intervals. Heat treatment steps within the context of the invention refer to heat treatment performed in several temporally spaced-apart steps. For example, a step is performed, whereafter the produced component is cooled down, maintained at a steady state, whereafter a next treatment step is performed with a time offset.

In another preferred modified embodiment of the present invention, the stabilizer is post-treated by shot-peening. More particularly, the coupled and heat-treated locations are post-treated by shot-peening. Shot-peening advantageously creates high-strength mechanical properties in the surface region.

The method according to the invention for producing a stabilizer, wherein at least two stabilizer components are connected with one another by thermal joining, is characterized in that the heat-affected zone created with this thermal joining is heat-treated.

In the context of the invention, the stabilizer components are coupled by thermal joining. Depending on the joining process, a more or less extended heat-affected zone is created in the microstructure surrounding the joint zone. This heat-affected zone and the joint seam located therein are heat-treated after thermal joining. This changes the microstructure, so that weakening produced by the thermal joining or undesirable hardening is compensated by the heat post-treatment.

Within the context of the invention, the method is further characterized in that the following method steps are performed before heat treatment:
Providing a tube;
Upsetting a tube end of the tube, with substantially constant outside diameter and reduced inside diameter;
Expanding the upset tube end to a final dimension in one or more expansion operations;
Materially connecting the upset and expanded tube end with a connection region of the actuator by thermal joining.

In the context of the invention, the thermal heat treatment of the heat-affected zone created by thermal joining as well as of the joint seam located therein is performed with the aforementioned method steps. The method steps, however, may also be performed in a different chronological order. Heat treatment is always performed after thermal joining. However, within the context of the invention, it need not be performed immediately after thermal joining, but may also have intermediate steps, i.e., may be performed at different times.

With the method according to the invention, a split stabilizer with an incorporated active actuator can be produced, which can be produced particularly cost-effectively. The stabilizer produced with the method of the invention has particularly high durability and optimal torsion characteristics. With the targeted reduction or elimination of the undesirable changes or weakening of the microstructure produced by thermal joining, the split stabilizer, in particular the coupling locations, can be optimized within the context of the invention so as to prevent oversizing. The stabilizer produced with the method according to the invention is hence optimized with respect to its weight and also its potential for transmitting forces.

In a particularly preferred modified embodiment, heat treatment is performed through induction, infrared heating, furnace heating and/or hot air heating. This provides the advantage that the heat treatment can be particularly targeted on the heat-affected zone. Regions outside the heat-affected zone are not touched at all by the aforedescribed heat treatment methods or only to an acceptable degree. In addition, induction heating and/or infrared heating enable particularly cost-effective heat treatment.

Within the context of the invention, heat treatment also refers to annealing, soft annealing, quenching and tempering. The need for and also the selection of the different heat treatment methods depend on the required load capacity of the connection as well as the employed materials. For example, the option for heat-treating the actuator is limited by the different employed electronic components. However, the electronic components are not damaged when heat treatment is targeted.

The method according to the invention is also characterized in that the joint seam can be post-treated by shot-peening. Shot-peening creates inherent stress in the marginal layer of the tube end or of the connecting region of the actuator and in the heat-affected zone. Preferably, the tube end is treated by shot-peening also from the inside. All these measures advantageously provide the high strength and the highly torsion torque to be transmitted in the particular application. Shot-peening is also advantageous for the joint seam produced by the thermal joining process as well as for the heat-affected zone.

According to another ensuing advantage, the material flow and the resulting stress inside the tube end can be intentionally controlled by separately upsetting and expanding the tube end as well as through expansion in several process operations. Expensive post-machining and correction processes in the process are almost entirely eliminated. This has again advantages for the production reliability and also for the expected production costs.

Within the context of the invention, the upset tube end is expanded to one-time to three-times the initial diameter. Particularly preferred, the tube end is expanded to 1.7-times to 2.2-times the initial diameter. Wall thickness of the upset and expanded tube end is one-time to three-times the initial wall thickness of the tube. Particularly preferred, the wall thickness of the upset and expanded tube end is 1.3-times to 1.6-times the wall thickness of the tube. This is particularly advantageous for coupling the tube end with the actuator by thermal joining. Due to the increase wall thickness compared to the initial state, a particularly good material connection is produced especially by taking into account a heat-affected zone of a thermal joint seam.

Within the context of the invention, a harmonic transition takes place between the upset and expanded tube end and the remaining part of the tube. In other words, the created bending radii from an expanded outside diameter to an outside diameter of the tube in the initial state are small. The transition occurs in form of a funnel and/or a trumpet. Within the context of the invention, the transition radii are selected so as to correspond to 3-times to 10-times the wall thickness of the tube in the initial state. Within the context of the invention, the transition between the upset and expanded outside diameter and the outside diameter of the tube is particularly in the form of a cone. In particular, the transition radii have a cone angle between 15° and 25°, particularly between 19° and 21°.

In a preferred embodiment of the method of the invention, the tubular stabilizer half and/or the actuator are heat-treated. Heat treatment can be performed during, between or after the individual process steps. Within the context of the invention, heat treatment refers to a heat treatment which, for example, encompasses all components through introduction of the components into a heat treatment furnace. Within the context of the invention, heat treatment may also be partial, so that for example only the tube end is heat-treated.

Within the context of the invention, heat treatment refers to annealing, soft annealing, quenching or hardening. The need for and the selection of the different heat treatment methods depend on the expected load carrying capacity of the connection and the employed materials. For example, the different employed electronic components limit the way in which the actuator can be heat-treat. Heating by induction can also be contemplated within the context of the invention.

In another preferred embodiment, the tube end is upset in a heated state. Moreover, within the context of the invention, the tube end is preferably expanded in a heated state. By forming the tube end in the respective heated state, the employed forming forces are reduced, as well as the created stress inside the respective formed component section and the adjacent sections. These two points again positively affect the production reliability and the production costs; for example, smaller and therefore less expensive machine tools are required as a result of the smaller forming forces. Attaining a required microstructure in targeted areas of the connecting region does not require expensive post-machining measures, which is also cost-effective for the entire production process.

In a particularly preferred embodiment, the tubular stabilizer half is formed and provided with different cross-sectional segments that are distributed over its length. Within the context of the invention, different cross-sectional segments refer to segments on the tubular stabilizer half that have different cross sections. The magnitude of the differences may be realized by way of the inside and outside diameter, the ratio of inside diameter to outside diameter and/or with a different wall thickness. Within the context of the invention, the tubular stabilizer half may be formed/machined before, during, between or after the individual process steps of the method of the invention for connecting the tube stabilizer half to the actuator. Especially for facilitating production, forming/machining is advantageously performed between or after the process. In another preferred modified embodiment, the stabilizer is coated. The coating may be an anticorrosion coating, a varnish or a similar coating. The coating affects here the durability by providing corrosion protection of the stabilizer, in particular the joint. The coating may also be a coating that further improves the mechanical properties of the stabilizer.

In another particularly preferred modified embodiment of the method of the invention, the tubes or stabilizer halves are additionally bent before, during or after the entire process. This bending hereby corresponds to shaping for the desired final configuration of the stabilizer. Concurrent with bending, or subsequent to bending, or before bending, an additional heat treatment of the tube in the region of the segments to be bent may be pending.

Additional advantages, features, properties and aspects of the present invention can be inferred from the following description, a preferred embodiment with reference to the schematic drawing. The drawing is provided to simplify understanding of the invention. It is shown in:

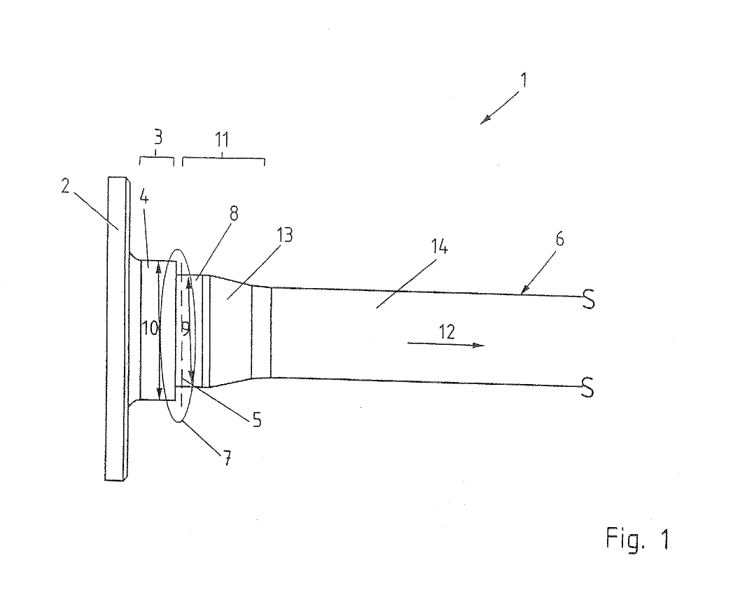

FIG. 1 a segment of a stabilizer according to the invention with a flange and a stabilizer profile;

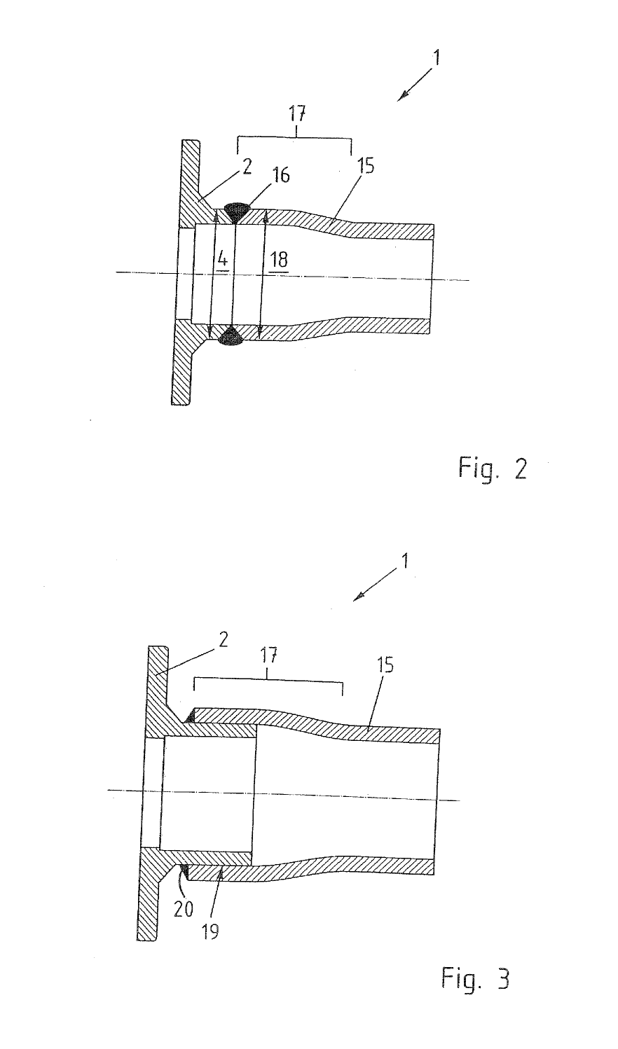

FIG. 2 a segment of a stabilizer with a butt joint produced according to the invention;

FIG. 3 a connection according to the invention between a stabilizer profile and a flange with an overlap;

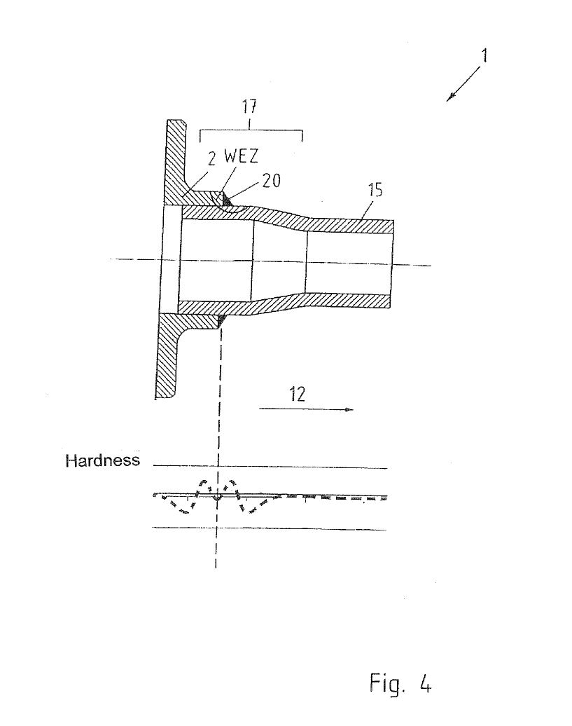

FIG. 4 an interference fit produced between the stabilizer profile and the flange;

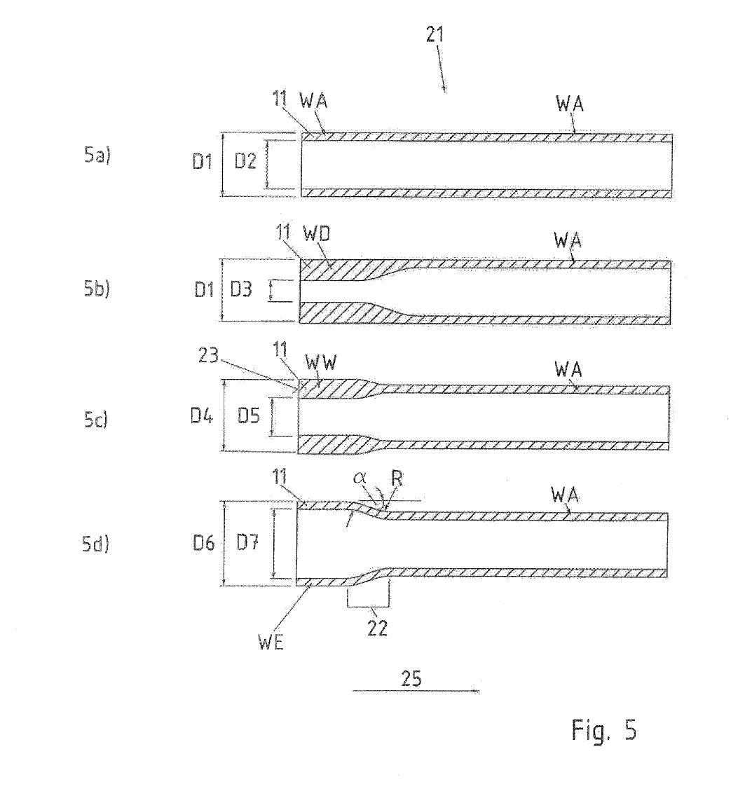

FIGS. 5a-d a method according to the invention for expanding a tubular stabilizer half with individual process steps; and

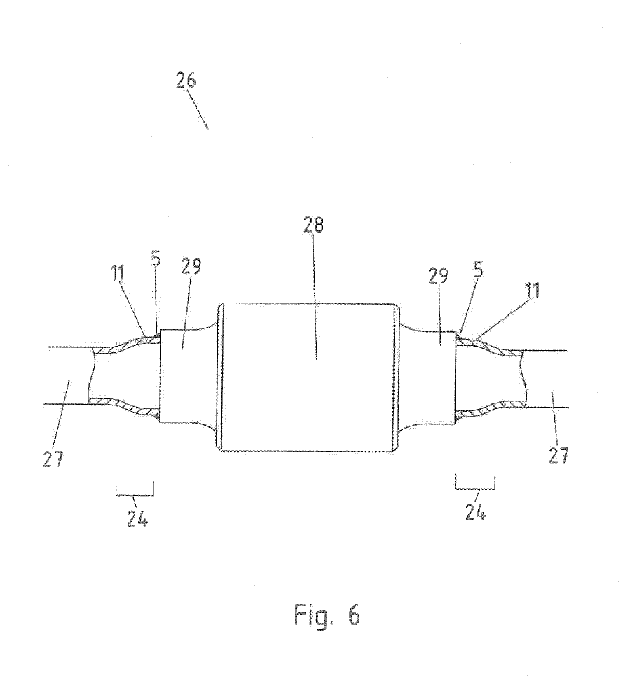

FIG. 6 a tubular stabilizer with two tubular stabilizer halves coupled to an actuator.

FIG. 1 shows a segment of a stabilizer 1 according to the invention. A flange 2 is illustrated which has a connection region 3 in form of a connecting piece 4. A stabilizer profile 6 is coupled to the connecting piece 4 by way of a joint seam 5. A heat-affected zone 7 is located in the region of the joint seam 5.

According to the invention, the heat-effect zone 7 is post-treated by a heat treatment. The stabilizer half 6 has on its flange-side end an expansion 8. The expansion 8 has essentially an outside diameter 9 which corresponds to the outside diameter 10 of the connecting piece 4. A funnel-shaped connecting section 13 of the tube extends in the profile direction 12 from the flange-side tube end 11 of the stabilizer half 6.

The connecting section 13 transitions into the tube section 14 of the stabilizer half 6. The flange 2 is in turn coupled to an unillustrated actuator. On the right side of the stabilizer half 6, with reference to the image plane, the stabilizer 1 is coupled to unillustrated attachment points of the axle or the wheel support, respectively.

FIG. 2 shows a segment of a stabilizer 1 produced according to the invention. Illustrated here again is a flange 2 which is coupled to a tube profile 15 by butt joint. The joint seam is here formed in the form of an I-seam 16. The tube profile 15 itself is expanded on its flange-side end 17 so that the outside diameter of the flange 2 is substantially identical to the outside diameter 18.

FIG. 3 shows a second modified embodiment of a segment of a stabilizer 1. The tube profile 15 herein overlaps at least partially the flange 2 in the region of the flange-side end 17. Within the context of the invention, the overlap may also be constructed as an interference fit. The flange 2 and the tube profile 15 are also connected with one another via a fillet weld 20, which is at least partially post-heat-treated with the method of the invention. Within the context of the invention, an additional positive engagement or a non-positive and/or material engagement in form of, for example, an adhesive joint can be formed in the region of the overlap 19.

FIG. 4 shows another modified embodiment of a segment of a stabilizer 1 according to the invention in form of a tubular stabilizer. The tube profile 15 is hereby inserted into the flange 2. The insertion takes place at the flange-side end 17 of the tube profile 15 and can be constructed, in analogy to FIG. 3, for example as an interference fit and the like. In addition, the stabilizer 1 according to FIG. 4 is also materially coupled via a fillet weld 20. The fillet weld 20 and the heat-affected zone WEZ surrounding the fillet weld 20 are at least partially post-heat-treated with the method according to the invention. FIG. 4 shows additionally a schematic diagram of the hardness curve in the profile direction. As can be seen, the hardness strongly varies in the region of the weld seam, as indicated by the dashed line L. After the at least partial heat treatment according to the invention, a homogeneous hardness curve is obtained, as indicated by the continuous line H.

FIG. 5a shows a first method step, whereby a tube 21 is provided, which is in an initial state and is expended into a conical segment 22. In the initial state, the tube 21 has an outside diameter D1 and an inside diameter D2.

FIG. 5b shows a second method step, wherein in a second method step a tube end 11 is upset. The tube end 11 has during the upsetting process essentially the outside diameter D1, but a reduced inside diameter D3. During and after the upsetting process, the inside diameter D3 is smaller than the inside diameter D2 of the initial state. The tube end 11 has therefore a thicker wall thickness WD compared to the wall thickness WA of the rest of the tube 21.

In another method step, the tube end 11 is expanded. FIG. 5c shows a possible variant of a first expansion step. As seen in FIG. 5c, the tube end 11 attains through the expansion a larger outside diameter D4 compared to the outside diameter D1 of the initial state. Also enlarged is an expanded inside diameter D5. The expanded inside diameter D5 is hereby greater than the reduced inside diameter D3. Depending on the degree of expansion performed in this method step, the expanded inside diameter D5 is smaller than, identical to, or greater than the inside diameter D2 of the initial state. At the same time, the wall thickness WW decreases during the expansion process due to a change in the cross-sectional area 23 in the region of the tube end 11. The wall thickness WW during the expansion process and after termination of the expansion process is smaller than the wall thickness WD of the tube end 11 during and after the upsetting process.

FIG. 5d shows the tube end 11 after termination of the method steps upsetting and expanding. The expanded tube end 11 has in a tube end region 24 a final outside diameter D6 and a final inside diameter D7. The outside diameter D6 of the tube end and the inside diameter D7 of the tube end are here greater than outside diameter D1 of the initial state and the inside diameter D2 of the initial state. The end region 24 of the tube is tapered in the tube direction from the final outside diameter D6 and a final inside diameter D7. The tube 21 has in the tube end region 24 a final wall thickness WE.

FIG. 5d shows further a conical segment 21, which is delimited in the tube direction 25 by two radii R. The conical segment 22 located between the bending radii has in relation to the expanded tube end 11 and the tube 21 a cone angle α between 15° and 25°, preferably between 19° and 21°.

In the illustrated variant of the embodiment, the final wall thickness WE corresponds substantially to the wall thickness WA in the initial state. The end region 24 of the tube is tapered in the tube direction 25, with the end region 24 of the tube having in the illustrated variant of the embodiment substantially the same final wall thickness WE across the entire region.

FIG. 6 shows a tubular stabilizer 26 with two tubular stabilizer halves 27 and an actuator 28. The tube ends 11, 24 of the tubular stabilizer halves 27 are coupled with the actuator 28 in a corresponding coupling region 29 of the actuator 28. The coupling is established by a joint seam 5 between the end region 24 of the tube and the coupling region 29.

### LIST OF REFERENCES SYMBOLS

1 Stabilizer
2 Flange
3 Connection region
4 Connection piece
5 Joint seam
6 Stabilizer profile
7 Heat-affected zone
8 Expansion
9 Outside diameter of 8
10 Outside diameter of 4
11 Tube end
12 Profile direction
13 Connection section
14 Tube segment
15 Tube profile
16 I-seam
17 Flange-side end
18 Outside diameter of 17
19 Overlap
20 Fillet weld
21 Tube
22 Conical section
23 Cross-sectional area
24 End region of the tube
25 Tube direction
26 Tubular stabilizer
27 Tubular stabilizer half
28 Actuator
29 Connection region
α Angle
H Hardness curve after heat treatment
L Hardness curve after thermal joining and before heat treatment
WEZ Heat-affected zone
D1 Outside diameter initial state
D2 Inside diameter initial state
D3 Reduced inside diameter
D4 Expanded outside diameter
D5 Expanded inside diameter
D6 Final outside diameter
D7 Final inside diameter
WD Thicker wall thickness
WA Wall thickness initial state
WW Wall thickness expansion process
WE Final wall thickness
R Radius

What is claimed is:

1.-16. (canceled)

17. A stabilizer, comprising at least two stabilizer components which are materially coupled with one another by a thermal joint in a heat-affected zone, which heat-affected zone is at least partially heat-treated after the thermal joint is formed.

18. The stabilizer of claim 17, wherein the thermal joint is constructed as a circumferential joint seam, wherein the heat-affected zone surrounds the joint seam, and wherein the joint seam and the heat-affected zone are at least partially heat-treated.

19. The stabilizer of claim 17, wherein the at least two stabilizer components comprise two stabilizer halves, the stabilizer further comprising an actuator coupling two stabilizer halves with one another.

20. The stabilizer of claim 19, wherein a stabilizer half comprises a flange and a stabilizer profile which is materially coupled to the flange.

21. The stabilizer of claim 20, wherein the stabilizer profile is constructed as a tubular profile or as a profile made of a solid material.

22. The stabilizer of claim 20, wherein the flange comprises a connection region on a side facing the profile.

23. The stabilizer of claim 22, wherein the connection region is constructed as a connecting piece.

24. The stabilizer of claim 20, wherein the stabilizer profile is constructed as a tubular profile that is expanded on a tube end facing the flange relative to an initial diameter of the tubular profile.

25. The stabilizer of claim 24, wherein a wall thickness on the expanded tube end substantially corresponds to a wall thickness of the unexpanded tubular profile.

26. The stabilizer of claim 23, wherein an outside diameter of the connecting piece corresponds substantially to an outside diameter of an expanded end of the tubular profile.

27. The stabilizer of claim 17, wherein the at least partial heat treatment is performed in several stages and/or steps.

28. The stabilizer of claim 17, wherein the heat-affected zone is treated by shot-peening after being at least partially heat-treated.

29. The stabilizer of claim 17, wherein a microstructure of the heat-treated heat-affected zone is continuously homogeneous.

30. The stabilizer of claim 17 wherein a microstructure of the heat-treated heat-affected zone is a fine-grain martensitic microstructure.

31. A method for producing a stabilizer, comprising the steps of:
connecting at least two stabilizer components with one another by thermal joining, thereby producing a heat-affected zone, and
heat-treating the heat-affected zone produced by thermal joining.

32. The method of claim 31, further comprising before the heat-treating step the steps of:
providing a tube;
upsetting a tube end of the tube while maintaining a substantially constant outside diameter and decreasing an inside diameter;
expanding the upset tube end to a final dimension in one or more expansion operations; and
materially connecting the upset and expanded tube end with a connection region of an actuator by thermal joining.

33. The method of claim 32, wherein the connection region comprises a flange.

34. The method of claim 31, wherein heat treating is performed with induction and/or infrared heating.

35. The method of claim 31, wherein the heat-affected zone is post-treated by shot-peening.

36. The method of claim 35, wherein a joint seam in the heat-affected zone is post-treated by shot-peening.

37. The method of claim 31, further comprising coating the stabilizer.

38. The method of claim 32, wherein the at least two stabilizer components comprise a stabilizer half, further comprising bending the tube or the stabilizer half, or both.
